(19) United States
(12) Patent Application Publication
(10) Pub. No.: US 2002/0130952 A1
(43) Pub. Date: Sep. 19, 2002

(54) Compact light source employing electronically controlled half wave plates

(76) Inventors: John J. Galt, Glendale, CA (US); James B. Pearman, Glendale, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/008,046

(22) Filed: Nov. 7, 2001

Related U.S. Application Data
(63) Continuation of application No. 09/764,915, filed on Jan. 17, 2001, now abandoned.
Application No. 09/764,915 is a continuation of application No. 09/379,033, filed on Aug. 23, 1999, now abandoned.
Application No. 09/379,033 is a continuation of application No. 08/821,256, filed on Mar. 20, 1997, now abandoned.

(51) Int. Cl. H04N 9/10

(52) U.S. Cl. 348/98

(57) ABSTRACT

A compact light source for an optical color correction system selectably removes under electronic control zero, one, two, or all three primary color components from an input beam of white light. The system polarizes the input beam linearly and passes it through three filter assemblies. Each filter assembly comprises a half-wave plate whose optic axis may be rotated between two different positions under electronic control and a colored polarizer. With the optic axis in one position, the half-wave plate passes the incoming polarized light unaltered. With the optic axis in a second position, the half-wave plate rotates the incoming polarized light. The colored polarizer removes a primary color component only when the light passing through it is polarized along its principal axis, and passes the incoming light unaltered when that light is polarized along the orthogonal axis. By suitable electronic manipulation of the optic axes of the half-wave plates, the overall effect of the three filter assemblies may be arranged so as to remove zero, one, two, or all three primary color components from the input beam.

### BACKGROUND OF THE INVENTION

1. Field of the Invention

This invention relates to the field of film and video processing systems, and in particular to light sources suitable for film and video processing.

2. Related Art

Technologies for recording and reproducing color are imperfect in a number of ways, e.g., in the limited range of colors which can be reproduced. Furthermore, human color vision perceives colors differently depending on the surrounding context, level of illumination, and other factors. Because of these difficulties, it is common to perform color correction on color photographs, videotapes, and films.

Color correction is the use of controls which adjust the colors recorded in a film, videotape, or other color image recording medium in order to make those colors appear more natural and attractive. There are two fundamentally different ways to perform color correction, optical and electronic. In optical color correction, one alters the spectral composition of light which either represents the recorded material or is used to read the recorded material. In electronic color correction, one represents the recorded color values by electronic signals or as digital quantities and alters them with analog or digital electronic equipment. Optical color correction is most suitable for overall adjustments of a scene's color cast, while electronic color correction is more appropriate for finer adjustments.

The fundamental requirement for optical color correction is the ability to shape the spectral composition of light. Fixed light filters, for example blue filters, are well known and widely used in still photography. However, in dealing with moving images on film or video, it is generally desired to change the filtering effect between takes and also within each take as the camera moves or zooms or objects of different colors come into or exit the frame. In order to achieve this rapid change, one must be able to alter the spectral characteristics of light under electronic control.

Color correction is employed in a number of contexts in video and film processing. The context which the inventors have had principally in mind is the conversion of motion picture film to video. This conversion is performed by machines called “telecines.” A design for a telecine is disclosed in U.S. Pat. No. 5,428,387 (“the '387 patent”), issued to the present inventors on Jun. 27, 1995 and assigned to Sony Electronics Inc., which is incorporated herein by reference.

A telecine of the type disclosed in the '387 patent exposes a motion picture film frame by frame, creating an optical film image which is recorded by a video camera. Such a telecine contains a mechanism which pulls each individual frame of film quickly into a particular position where a beam of light shines through it. That mechanism holds the film frame in place there long enough for it to be exposed into the video camera and for the video camera to capture the image in video. By controlling the spectral composition of the beam of light which exposes the film, optical color correction may be achieved.

In the prior art telecine described in the '387 patent, optical color correction is accomplished by using three different light sources, coming from three different lamps, one for each of the primary colors red, green, and blue. The intensity of the light produced by each of the three lamps is controlled by variable voltage power supplies. In addition, the output of each lamp passes through a fast-acting mechanical light valve. This system is bulky, dissipates a good deal of heat, and is limited by the use of moving parts.

### SUMMARY OF THE INVENTION

It is consequently an objective of the invention to produce a light source suitable for an optical color correction system, allowing precise electronic control of the frequency content of light emanating from a single source. It is a further objective of the invention to perform this function by means of a highly compact assembly suitable for use in very tight spaces.

The light source of the invention employs a linear polarizer followed by three filter assemblies in series. Each filter assembly has two states. In one state, the filter assembly eliminates a predetermined band of frequencies from the incoming light. In the second state, the filter assembly passes the incoming light without altering its frequency content.

Each filter assembly consists of a half-wave plate in series with a colored polarizer. The optic axis of the half-wave plate is electronically controllable between two positions, which give rise to the two states of the filter assembly. The colored polarizer transmits light of all wavelengths if the light is linearly polarized along one axis, but only transmits light of certain wavelengths if the light is linearly polarized along an axis perpendicular to that axis, absorbing the light at other wavelengths.

The linear polarizer at the input of the series of filter assemblies receives light from a white light source and makes it linearly polarized with a known polarization axis, which we may refer to as the Y axis. In each filter assembly, the half-wave plate is so aligned that one of the two possible positions of its optic axis is parallel to the Y axis, while the other possible position is at a 45° angle to the Y axis. With the optic axis aligned parallel to the Y axis, the half-wave plate transmits light which is linearly polarized along the Y axis unaltered. With the optic axis aligned at 45° to the Y axis, in contrast, the half-wave plate rotates the polarization of such linearly polarized light so that it is linearly polarized perpendicular to the Y axis.

The light exiting the half-wave plate enters the colored polarizer. The colored polarizer is so aligned that it transmits all frequencies when the incoming light is polarized along the Y axis, whereas it eliminates certain frequencies when the incoming light is polarized perpendicular to the Y axis. With this orientation, by controlling the half-wave plate, one can control whether the colored polarizer will pass all frequencies or will eliminate certain frequencies. This allows the desired electronic control of the frequency content of the light to be achieved.

### BRIEF DESCRIPTION OF THE DRAWINGS

FIG. 1 depicts the light source of the invention.

FIGS. 2a and 2b (prior art) depict the effect of the preferred ferroelectric liquid crystal half-wave plate on linearly polarized light when it is in the “on” state.

FIGS. 3a and 3b (prior art) depict the effect of the preferred ferroelectric liquid crystal half-wave plate on linearly polarized light when it is in the “off” state.

FIGS. 4a and 4b depict the effect of a filter assembly of the invention on a beam of vertically polarized light when the half-wave plate is “on” (FIG. 4a) and when it is “off” (FIG. 4b).

FIG. 5 depicts the use of the light source of the invention to perform color correction in a telecine.

### DETAILED DESCRIPTION OF THE INVENTION

In the following description, for purposes of explanation, specific nomenclature is set forth to provide a thorough understanding of the present invention. However, it will be apparent to one skilled in the art that these specific details are not required in order to practice the present invention. In other instances, well known circuits and devices are shown in block diagram form in order not to obscure the present invention unnecessarily.

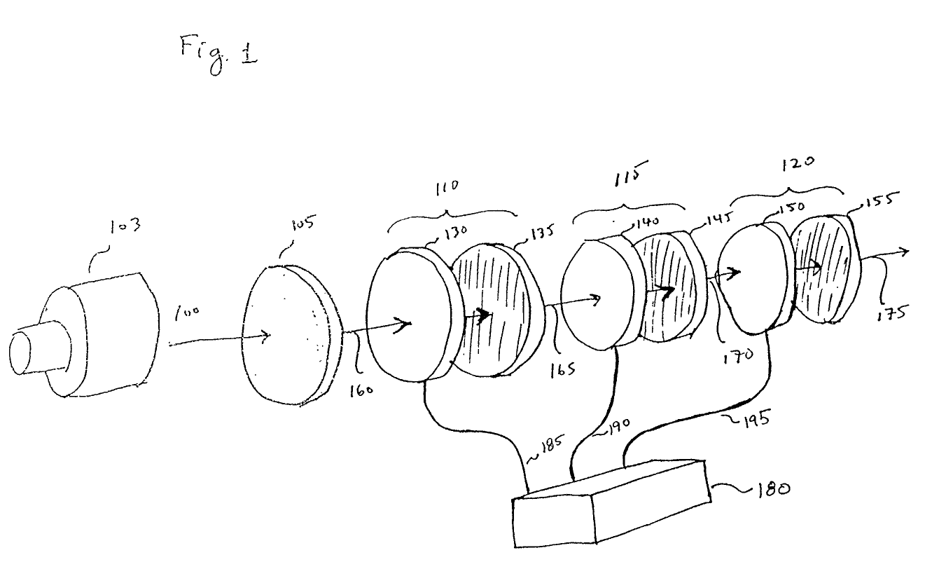

FIG. 1 depicts the overall structure of a preferred embodiment of the light source of the invention. A light beam 100 generated by a lamp 103 enters a linear polarizer 105, which polarizes the beam along the vertical axes, and subsequently passes through three filter assemblies 110, 115, 120. Each filter assembly 110, 115, 120 comprises both an electronically controllable half-wave plate 130, 140, 150 and a colored polarizer 135, 145, 155. An electronic controller 180 drives the three electronically controllable half-wave plates employing electrical signal lines 185, 190, 195. Each of the colored polarizers 135, 145, 155 transmits light of all wavelengths if the light is linearly polarized along one axis (the polarizer's “principal” axis). The same colored polarizer only transmits light of certain wavelengths if the light is linearly polarized along an axis perpendicular to the principal axis, absorbing the light at other wavelengths. In FIG. 1, the principal axes of the colored polarizers 135, 145, 155 are vertical.

The colored polarizers 135, 145, 155 are preferably chosen so that they correspond to the subtractive primaries cyan, magenta, and yellow. Thus, when horizontally polarized light passes through polarizer 135 corresponding to cyan, the red component of that light will be absorbed and only the green and blue components will be transmitted. Similarly, when horizontally polarized light passes through polarizer 145 corresponding to magenta, the green component of that light will be absorbed and only the red and blue components will be transmitted. Likewise, when horizontally polarized light passes through polarizer 155 corresponding to yellow, the blue component of that light will be absorbed and only the red and green components will be transmitted.

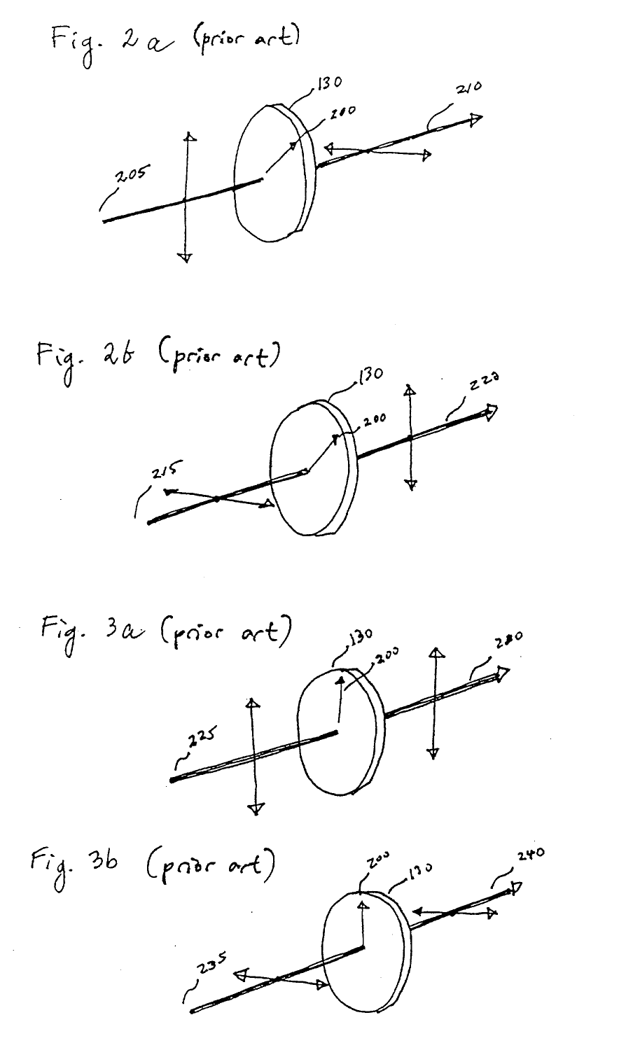

FIGS. 2a, 2b, 3a and 3b depict the operation of the electronically controllable half-wave plate 130. (The other two half-wave plates 140 and 150 operate identically.) In the preferred embodiment, the half-wave plates are ferroelectric liquid crystals marketed, for example, by Displaytech Inc. of Boulder, Colo. Such crystals have the advantage of being able to change state in tens of microseconds. FIGS. 2a and 2b depict the effect of the half-wave plate 130 on linearly polarized light when the half-wave plate 130 is in its “on” state. In that case, the optic axis 200 of the half-wave plate 130 is at a 45° angle to the vertical. An incoming beam of linearly polarized light 205, with its polarization angle vertical, consequently experiences a 90° rotation in the polarization angle, resulting in an output beam of linearly polarized light 210 whose polarization angle is horizontal. Similarly, as depicted in FIG. 2b, an incoming beam 215 with a horizontal polarization angle also experiences at 90° rotation, emerging as an output beam 220 with a vertical polarization angle.

FIGS. 3a and 3b depict the effect of the half-wave plate 130 on linearly polarized light when the half-wave plate 130 is in its “off” state. In that case, the optic axis 200 of the half-wave plate 130 is vertical. An incoming beam of linearly polarized light 225, with its polarization angle vertical, consequently experiences no rotation in the polarization angle, resulting in an output beam of linearly polarized light 230 whose polarization angle is also vertical. Similarly, as depicted in FIG. 3b, an incoming beam 235 with a horizontal polarization angle also experiences no rotation, emerging as an output beam 240 with a horizontal polarization angle.

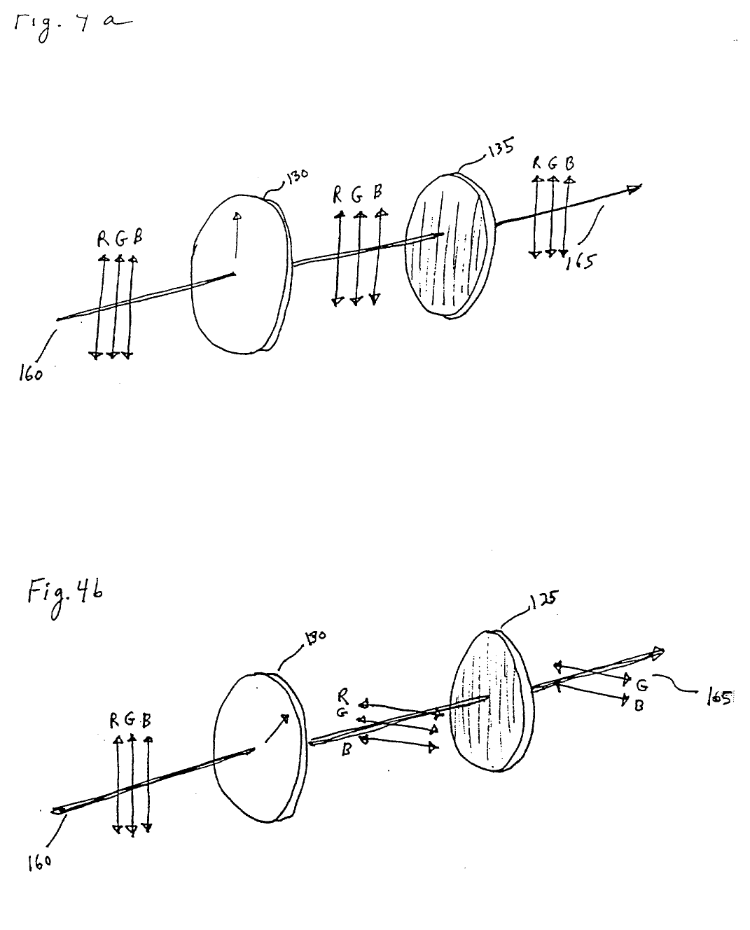

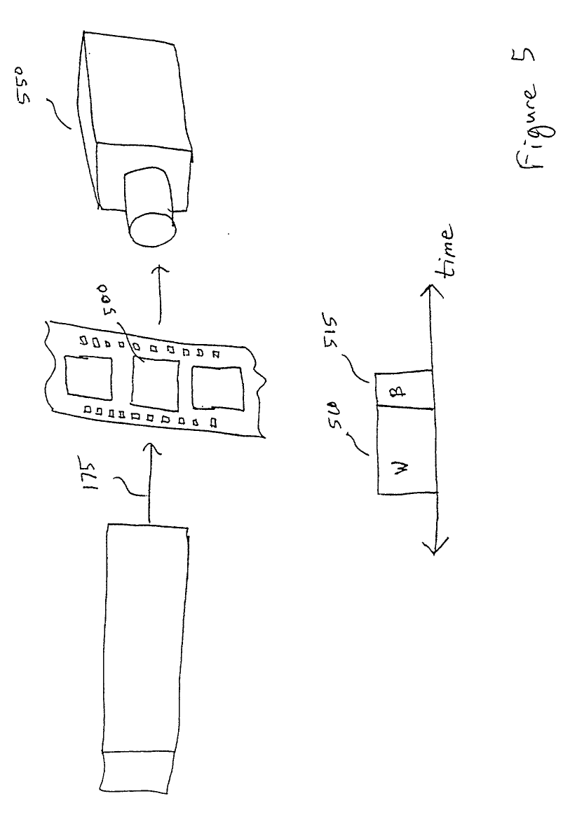

FIGS. 4a and 4b depict the effect of filter assembly 110, comprising half-wave plate 130 followed by the cyan polarizer 135, on light beam 160 emerging from the linear polarizer 100. Light beam 160 is a linearly polarized beam of white light with its polarization angle vertical. It consequently contains R, G, and B color components. When the half-wave plate 130 is off, as shown in FIG. 4a, the beam 160 passes through the half-wave plate unaltered and enters cyan polarizer 135. Because the principal axis of cyan polarizer 135 is vertical, that polarizer also does not alter the beam contents, and the output beam 165 still contains R, G, and B color components.

In contrast, as depicted in FIG. 4b, when the half-wave plate 130 is on, the beam 160 experiences a 90° angle rotation and emerges horizontally rather than vertically polarized. Cyan polarizer 135 consequently filters out the R spectral component of the beam. The resulting output beam 165 contains only G and B color components, and is horizontally polarized.

The operation of the half-wave plate 130 just described may be summarized in the following table. R, G, and B denote red, green, and blue spectral content; [symbol] denotes linear polarization along the vertical axis; and [symbol] denotes linear polarization along the horizontal axis.

| Plate 130 | Beam 160 | Beam 165 |
|---|---|---|
| Off | RGB [symbol] | RGB [symbol] |
| On | RGB [symbol] | GB [symbol] |
| Off | RGB [symbol] | GB [symbol] |
| On | RGB [symbol] | RGB [symbol] |

Stated succinctly, when the half-wave plate 130 is on, it rotates the direction of polarization of beam 160; when the direction of polarization coming out of the half-wave plate is horizontal, cyan polarizer 135 filters out the R spectral component.

Filter assemblies 115 and 120 operate very similarly to filter assembly 110, except that they filter out different spectral components because they have colored polarizers with different spectral responses. This is summarized in the following two tables:

| Plate 140 | Beam 165 | Beam 170 |
|---|---|---|
| Off | RGB [symbol] | RGB [symbol] |
| On | RGB [symbol] | RB [symbol] |
| Off | RGB [symbol] | RB [symbol] |
| On | RGB [symbol] | RGB [symbol] |

| Plate 150 | Beam 170 | Beam 175 |
|---|---|---|
| Off | RGB [symbol] | RGB [symbol] |
| On | RGB [symbol] | RG [symbol] |
| Off | RGB [symbol] | RG [symbol] |
| On | RGB [symbol] | RGB [symbol] |

The following table shows the effect on the output beam spectral content of turning the half-wave plates 130, 140 and 150 on and off.

| 130 | 140 | 150 | Beam 160 | Beam 165 | Beam 170 | Beam 175 |
|---|---|---|---|---|---|---|
| Off | Off | Off | RGB [symbol] | RGB [symbol] | RGB [symbol] | RGB [symbol] |
| Off | Off | On | RGB [symbol] | RGB [symbol] | RGB [symbol] | RG [symbol] |
| Off | On | Off | RGB [symbol] | RGB [symbol] | RB [symbol] | R [symbol] |
| Off | On | On | RGB [symbol] | RGB [symbol] | RB [symbol] | RB [symbol] |
| On | Off | Off | RGB [symbol] | GB [symbol] | B [symbol] | [symbol] |
| On | Off | On | RGB [symbol] | GB [symbol] | B [symbol] | B [symbol] |
| On | On | Off | RGB [symbol] | GB [symbol] | GB [symbol] | GB [symbol] |
| On | On | On | RGB [symbol] | GB [symbol] | GB [symbol] | G [symbol] |

It is thus seen that by suitably driving the half-wave plates 130, 140, and 150, it is possible to generate output light beams 175 of eight different spectral compositions. These eight spectral compositions may be described succinctly as: no beam, red beam, green beam, blue beam, red+green beam, red+blue beam, green+blue beam, and white (red+blue+green) beam. In effect, the light source allows one to generate an output consisting of any combination of a red beam, blue beam, and green beam. Furthermore, because the half-wave plates 130, 140, and 150 change state rapidly, within some tens of microseconds, it is possible to apply each of the eight spectral compositions during a precisely determined time interval. This allows one in many applications to simulate the effect of continuous variation of the beam's spectral composition.

Consider as an example the use of the light source of the invention to perform color correction in a telecine which employs a CCD imager, like the telecine described in the '387 patent. CCD imagers have a large number of photosensitive cells arranged in a rectangular array. Each photosensitive cell corresponds to some small area within the image. In a color camera, three separate CCD arrays of cells sense light in three different frequency ranges, prisms being used to split the incoming light beam into those frequency ranges.

CCD arrays have a sampling period, say 1/60th of a second. During the sampling period, each of the photosensitive cells senses incoming photons and accumulates a charge proportional to the number of incoming photons. At the end of the sampling period, the accumulated charge in each cell is recorded in a storage device, the cell is reset to zero, and measurement of the number of incident photons starts anew. In a CCD array, then, the total amount of light that hits each cell during the 1/60th of a second sampling period is the only thing that matters as regards the array's output. The end result is the same regardless of whether the light all hits the cell in a short subinterval within the 1/60th of a second sampling period, or at a uniform rate throughout the 1/60th of a second sampling period.

The light source of the invention, which produces only one of eight distinct beam spectral compositions at any one time, may be employed to drive a CCD imager by having a white beam on for a certain period of time and beams of other colors on for subsequent periods of time. Consider a telecine as depicted in FIG. 5 where the light source's output beam 175 traverses a film frame 500 and then enters a CCD camera 505. One can convert film frame 500 to video, giving it a bluish cast (for example), by first driving the electronic half-wave plates so as to produce white light for a certain period of time 510, and then driving those plates so as to produce blue light for an additional period of time 515, both of these periods of time falling within a single CCD array sampling period. Because the electronic half-wave plates can change state very rapidly, the beginning and end of time periods 510 and 515, and thus the amount of blue in the color cast of the video fields corresponding to film frame 500, may be set with great precision.

Although the light source of the invention was designed for use in a telecine, it will be readily apparent to those skilled in the art that it may also be employed in other applications requiring a compact apparatus for generating light with electronically controllable spectral characteristics. In particular, the invention may be employed in a color printer or color copier.

We claim:

1. An electronically controllable optical filter receiving an input light beam and producing an output light beam, said optical filter comprising:
an electronically controllable polarizer which alters the polarization state of said input light beam under electronic control producing a second light beam, and
a polarization-dependent optical element which alters the spectral composition of said second light beam as a function of the polarization state of said second light beam.

2. The electronically controllable optical filter of claim 1, where said electronically controllable polarizer comprises:
a linear polarizer generating a linearly polarized beam of light, and means for rotating the polarization angle of said linearly polarized beam of light under electronic control.

3. The electronically controllable optical filter of claim 2, where said means for rotating the polarization angle comprises a half-wave plate whose optic axis varies under electronic control.

4. The electronically controllable optical filter of claim 3, where said half-wave plate comprises a ferroelectric liquid crystal.

5. The electronically controllable optical filter of claim 1, where said polarization-dependent optical element removes from said second light beam a predetermined additive primary color when said second light beam is in a predetermined polarization state.

6. The electronically controllable optical filter of claim 1, where said polarization-dependent optical element comprises a dichroic filter.

7. A light source producing an output light beam, said light source comprising:
a lamp producing an input light beam of white light,
an electronic controller,
a first electronically controllable optical element which removes a first spectral component from said input light beam when commanded to do so by said electronic controller, producing a second light beam,
a second electronically controllable optical element which removes a second spectral component from said second light beam when commanded to do so by said electronic controller, producing a third light beam, and
a third electronically controllable optical element which removes a third spectral component from said third light beam when commanded to do so by said electronic controller, producing said output light beam,
thereby allowing the spectral composition of said output light beam to be controlled electronically.

8. The light source of claim 7, where said first electronically controllable optical element comprises
an electronically controllable polarizer which alters the polarization state of said input light beam under electronic control producing a fourth light beam, and
a polarization-dependent optical element which alters the spectral composition of said fourth light beam as a function of the polarization state of said fourth light beam, producing said second light beam.

9. The light source of claim 7, where said first, second, and third spectral components are additive primaries, thereby allowing the spectral composition of said output light beam to be controlled electronically to eight distinct characteristics each corresponding to some combination of primaries.

10. A method for controlling the spectral composition of an output light beam, said method comprising the steps of
producing an input light beam,
generating a first, second, and third electronic signals,
passing said input light beam through a first electronically controlled optical element which removes a first spectral component from said input light beam when commanded to do so by said first electronic signal, producing a second light beam,
passing said second light beam through a second electronically controlled optical element which removes a second spectral component from said input light beam when commanded to do so by said second electronic signal, producing a third light beam, and
passing said third light beam through a third electronically controlled optical element which removes a third spectral component from said input light beam when commanded to do so by said third electronic signal, producing said output light beam,
thereby allowing the spectral composition of said output light beam to be controlled electronically.

11. The method of claim 10, said step of passing said input light beam through a first electronically controlled optical element comprising the steps of
passing said input light beam through an electronically controllable polarizer which alters the polarization state of said input light beam if said first electronic signal so directs, producing a fourth light beam, and
passing said fourth light beam through a polarization-dependent optical element which alters the spectral composition of said fourth light beam as a function of the polarization state of said fourth light beam, producing said second light beam.

12. The method of claim 10, where said first, second, and third spectral components are additive primaries, thereby allowing the spectral composition of said output light beam to be controlled electronically to eight distinct characteristics each corresponding to some combination of primaries.

13. A method of converting motion picture film comprising a plurality of frames to video, said method comprising the steps of:
producing an input light beam,
passing said input light beam through a first electronically controlled optical element which removes a first spectral component from said input light beam as directed by a first electronic signal, producing a second light beam,
passing said second light beam through a second electronically controlled optical element which removes a second spectral component from said input light beam as directed by a second electronic signal, producing a third light beam,
passing said third light beam through a third electronically controlled optical element which removes a third spectral component from said input light beam as directed by a third electronic signal, producing said output light beam, and
for each frame in said plurality of frames, performing the steps of:
generating a plurality of time periods,
for each time period in said plurality of time periods, performing the steps of:
driving said first, second, and third electronic signals so as to determine the spectral characteristics of said output beam,
illuminating said frame during said time period with said output beam to create an optical film image, and
detecting said optical film image with an imaging detector; and then
generating a video field at the output of said imaging detector.
